(19) United States
(12) Patent Application Publication
(10) Pub. No.: US 2021/0033264 A1
(43) Pub. Date: Feb. 4, 2021

(54) LIGHTING APPARATUS FOR HAZARDOUS AREAS

(71) Applicant: OY MTG-MELTRON LTD, Helsinki (FI)

(72) Inventors: Kari Rinko, Helsinki (FI); Leo Hatjasalo, Helsinki (FI)

(21) Appl. No.: 17/067,134

(22) Filed: Oct. 9, 2020

Related U.S. Application Data
(63) Continuation of application No. 15/520,856, filed on Apr. 21, 2017.
(60) Provisional application No. 62/067,602, filed on Oct. 23, 2014.

(51) Int. Cl. F21V 15/01; F21V 25/12; F21V 31/04; F21V 29/89; F21V 3/02; F21V 31/00

(52) U.S. Cl. CPC F21V 15/01; F21V 25/12; F21V 31/04; F21Y 2103/10; F21V 3/02; F21V 31/005; F21V 29/89

(57) ABSTRACT

A lighting apparatus for hazardous environments, comprising at least one substantially point-like source of light, and a housing structure for said at least one substantially point-like source of light, defining at least a triple barrier protective encapsulation to seal and insulate said at least one source of light from the environment, wherein said triple barrier protective encapsulation is at least partially optically transmissive to enable light propagation from said at least one source of light to the environment at predefined wavelengths.

### FIELD OF THE INVENTION

The present invention generally relates to illumination and lighting. Especially, however not exclusively, the invention pertains to lighting equipment for use in hazardous spaces.

### BACKGROUND

Hazardous areas may contain different concentrations of flammable liquids, gases, vapour and dust. When ignited by heat or even a relatively modest spark, which could be somewhat easily caused by an ordinary lighting apparatus or a related switch, massive destruction in the form of an explosion, etc. may take place considering e.g. an oil refinery, a mine or a plant that may be spatially very densely packed with dangerous, reactive materials in a confined atmosphere.

Therefore, various tests, standards and related certificates have been developed to provide proof on the protection level of equipment to be used in hazardous areas. A certificate may indicate e.g. the type and level of protection of the associated equipment. For instance, explosion protected products may exhibit identifier ‘Ex’ in their certificate label together with different more specific category and group definitions.

To meet the various requirements set by these standards, the equipment used in such risky conditions may have to be provided with explosion proof enclosure as well components, materials, and structures causing none or only insignificant sparking among various other safety features.

Notwithstanding the clearly advantageous features of existing lighting solutions designed for hazardous use scenarios, often incorporating e.g. fluorescent lamps, there is still room for improvement in terms of lighting efficiency, illumination controllability, and the overall security of the luminaire structure in view of the potentially labile, demanding environment where the solution is supposed to be installed.

### SUMMARY

An object of the present invention is to at least alleviate one or more of the aforesaid problems relating to the prior art.

The objective of the present invention can be achieved by the features of independent claims.

In one aspect, the invention relates to a lighting apparatus in accordance with independent claim 1. According to one embodiment of the invention a lighting apparatus for hazardous environment, comprises
at least one substantially point-like source of light such as a LED (light emitting diode), optionally a plurality of sources, and
a housing structure for said at least one substantially point-like source of light, defining at least a triple barrier protective encapsulation to seal and insulate said at least one source of light from the environment, wherein said triple barrier protective encapsulation is at least partially optically transmissive to enable light propagation from said at least one source of light to the environment at predefined wavelengths.

The desired minimum transmittance of the barrier structure depends on the embodiment but may be at least about 50%, 60%, 70%, 80%, 85%, 90%, or even 95% having regard to the target wavelengths. Yet, the barrier may be optically transparent (transmittance e.g. in the order of magnitude of 90% or higher) or translucent with considerable light scattering properties.

The triple barrier/layer housing structure for sealing the light source(s) may comprise a substantially cylindrical outer, or ‘cover’, element. Alternatively, the outer element may be of some other shape, e.g. having a square or rectangular cross-section in the case of some other, potentially still elongated, shape. Also spherical or cubical shapes are possible among other options. Generally, the shape may be symmetric or asymmetric.

The above considerations are generally equally applicable to an inner element that may be located within the outer element, i.e. the inner element is covered by the outer element. They may have a gap of air, other gaseous or generally fluidic, gel or even solid material in between. The intermediate material may bear desired functionalities. It may be optically substantially transparent but electrically insulating, for example. The elements may have a common support at either or both ends, for instance.

The outer or inner element may be substantially integral or monolithic by construction. The element may have been generally manufactured by molding, for example. It may still include deviant portions or discontinuities such as lead-through areas that have been used, prior to sealing, for disposing other elements such as a number of light sources, related components such as electrical conductors, control electronics, etc. within the element.

For example, end cap(s)/cover(s) of rigid and/or elastic material optionally provided with electrical wire or rod contacts for supplying current to the light source(s) may be utilized for hermetically closing the element end(s). The cap(s) may be common or separate to multiple nested elements such as the aforesaid outer and inner elements. For example, the outer element may be provided with more rigid (e.g. plastics) cap(s) whereas the inner element is provided with more elastic cap(s).

The outer and/or inner element may comprise at least one material selected from the group consisting of: glass, ceramic, plastic, polymer, and substantially UV resistant material. E.g. the surface and underlying materials of the element may differ.

The outer and/or inner element may comprise optically functional features such as surface relief forms or embedded relief forms, or optically functional nanoparticles, for instance.

Yet, the housing structure may comprise optically transmissive, optionally molded, core, or ‘innest’, material region, layer, element or block located within the inner element, thus further encapsulating the light source(s) to provide a third barrier of insulation against the environment. The core material may include elastomer, silicone, acrylic, polyurethane, olefin based elastomer, and/or polymer. It may be electrically insulating.

The core material may physically support or attach to the embedded light source(s) and related elements such as light source substrate/electronics, and optionally contact the inner element directly. These related elements such as the substrate (film, sheet, wiring board, etc.) or some other specific support structure may be assigned a thermal management function to conduct heat away from the light source(s), thus acting as a heat sink within the inner element and thereby increasing the long-term reliability of the solution due to a reduced heat stress easily deteriorating the light sources. For the purpose, suitable heat-conductive material such as aluminium may be exploited.

The utility of the present invention arises from a variety of factors depending on each particular embodiment thereof. The suggested robust, practically service free lighting apparatus includes at least a triple barrier housing structure for efficiently and reliably encapsulating the light sources and related electronics in order to minimize the risk of sparks or heat initiated explosions, fire, moisture damage, etc. The used barrier elements and structures including e.g. the related covers may be independently, carefully sealed.

The apparatus is suitable for general use although being principally designed for the aforementioned ‘Ex’ type environments, such as the ones commonly found in oil and gas industry, mines and other hazardous areas that may have different kinds of gaseous atmospheres and experience radical temperature changes. Besides the excellent sealing properties, the apparatus enables efficient lighting control by the embedded optically meaningful features such as surface relief structures e.g. in the form of gratings or other relief forms.

Various other advantages will become clear to a skilled person based on the following detailed description.

The expression “a number of” refers herein to any positive integer starting from one (1), e.g. to one, two, or three.

The expression “a plurality of” refers herein to any positive integer starting from two (2), e.g. to two, three, or four.

The terms “first” and “second” do not denote any order, quantity, or importance, but rather are used to distinguish one element from another.

Different embodiments of the present invention are disclosed in the dependent claims.

### BRIEF DESCRIPTION OF THE DRAWINGS

Next the invention will be described in greater detail with reference to the accompanying drawings, in which:

FIG. 1 illustrates an embodiment of a lighting apparatus in accordance with the present invention.

FIG. 2 illustrates the internals of the embodiment of FIG. 1 with the cover element removed.

### DETAILED DESCRIPTION

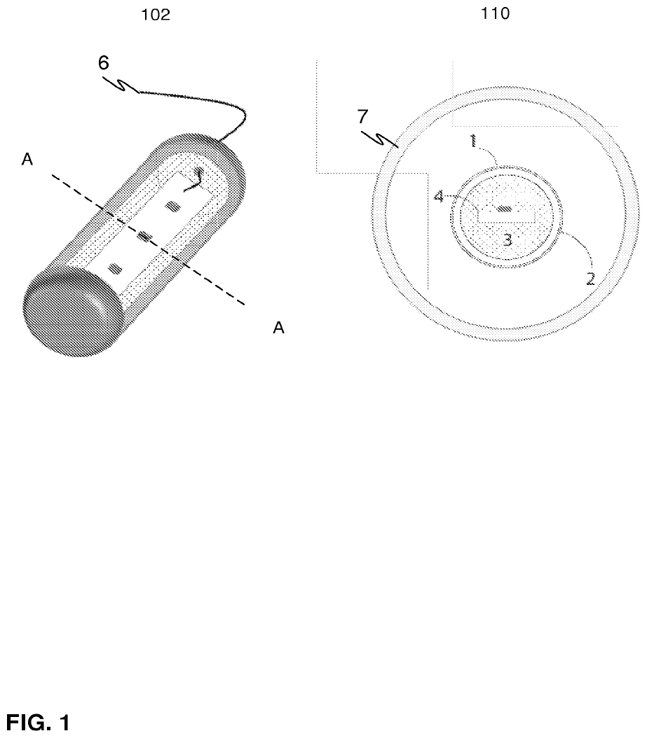

FIG. 1 illustrates, by way of example only, an embodiment of a lighting apparatus 102, or ‘light fixture’ or ‘luminaire’, in accordance with the present invention. On the right at 110, a cross-sectional view along line A-A is shown. The apparatus 102 comprises housing with an outer element 7 essentially defining in this example a symmetrical cover tube that may optionally be electrically conductive to fulfil ‘Ex’-area utilization criteria and requirements, for instance.

Base material of the outer tube 7 may include e.g. transparent glass, ceramic or polymer with or without special conductive coating. The used materials are preferably UV (ultraviolet) resistant.

Both end areas of the cover tube 7 are preferably hermetically sealed, optionally with an end cover such as a lid or cap possibly also carrying electrical rod or wired contacts 6 to enable energizing the light sources and potential related control electronics within the housing, essentially organized e.g. as a LED (light-emitting diode) strip 4 in this particular embodiment. The end cover may be, after manufacturing, permanently sealed or remain removable/operable, with or without tools, to facilitate serviceability of the internals of the luminaire.

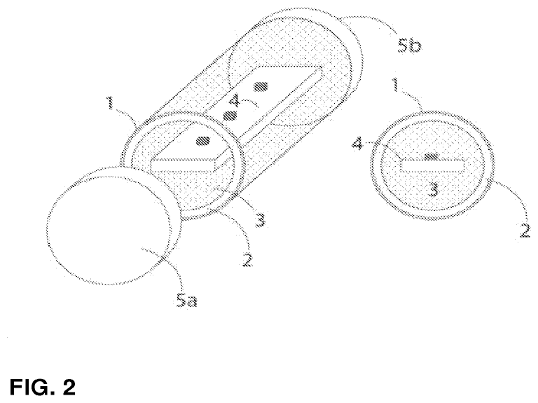

FIG. 2 illustrates the internals of the embodiment of FIG. 1 with the tubular outer cover element 7 removed.

Within the hollow space defined by the cover element 7, the inner element, preferably being or comprising a tube 1, is disposed. It may include e.g. transparent glass, ceramic or plastic material 2, which may inherently have or be specifically configured to carry optically functional characteristics for light control. It may exhibit optical management features such as three dimensional relief forms on the (inner/outer) surface and/or as embedded within the material for purposes such as light directing, collimation, diffusing, coloring (e.g. from white light), and/or generally establishing a desired light distribution. These functionalities can be fully integrated with the tube and/or assembled at close proximity thereto, either on the inside or outside. The optical features can be realized by refractive and/or diffractive surface reliefs, volume/cavity optics containing e.g. sub-micron or micron scale profiles, or volume scattering features. In addition to or instead of such features of the inner tube 1, in some embodiments the cover element 7 may incorporate similar characteristics.

Inside the tube 1, at least one light source is found e.g. in the form of one or a plurality of LED strips 4. The LEDs may be traditionally packaged ones or e.g. OLEDs (organic LED). Alternatively or additionally, some other applicable light sources could be applied. Source-emitted or finally outcoupled color is typically white, but basically any color/wavelength is possible including IR radiation. Light source may be provided with related substrate, control electronics and/or other assisting elements such as strip or sheet for cooling purposes.

Light source 4 is preferably fully encapsulated and sealed by a covering hermetic barrier (core) element or layer 3 that is sufficiently transparent with high enough transmittance according to the utilized criteria depending on the embodiment, and may implement color tuning and/or improve light extraction from the source 4, for example. Suitable materials and shapes, optionally reliefs, may again be used for optimized light transmission and control together with hermetic sealing and protection function. Encapsulating material may especially include silicone, polyurethane, acrylic, olefin based elastomer, or polymer, i.e. applicable material to avoid electric short circuits, sparks, and/or moisture contacts. The material may be solid or gel-like, for instance. It may be moldable, extrudable and/or curable during the manufacturing of the lighting apparatus.

The inner tube 1 may be finally sealed with permanent or detachable/operable (with or without tools) end covers such as caps 5a, 5b, which may contain e.g. rod or wired contacts for electrically connecting the light source 4 to the external power supply.

The caps of the inner 1 and cover (outer) 7 barrier tube elements may be shared or dedicated depending on the embodiment. The caps may lock the inner tube 1 in place within the cover tube 7.

1. A lighting apparatus (102) for hazardous environments, comprising
at least one substantially point-like source of light (4), and
a housing structure for said at least one substantially point-like source of light, defining at least a triple barrier protective encapsulation (1, 3, 7) to seal and insulate said at least one source of light from the environment, wherein said triple barrier protective encapsulation is at least partially optically transmissive to enable light propagation from said at least one source of light to the environment at predefined wavelengths.

2. The apparatus of claim 1, wherein the triple barrier encapsulation comprises a plurality of hollow, nested elements (1, 3, 7).

3. The apparatus of any preceding claim, wherein the housing structure comprises optically transmissive, optionally cylindrical, outer element (7) to provide a first barrier of insulation against the environment.

4. The apparatus of claim 3, wherein the outer element incorporates a functional coating, optionally conductive coating.

5. The apparatus of any preceding claim, wherein the housing structure comprises optically transmissive, optionally cylindrical, inner element (1) to provide a second barrier of insulation against the environment, wherein optionally remains a gap of gaseous substance such as air between the inner and outer elements.

6. The apparatus of any preceding claim, wherein any barrier element (1, 3, 7) comprises a number of optically functional features for controlling light, said features optionally comprising surface relief structures.

7. The apparatus of claim 6, wherein the features have at least one optical function selected from the group consisting of: light directing, collimation, diffusing, coloring, scattering, and distribution function.

8. The apparatus of any preceding claim, wherein any barrier element (1, 3, 7) comprises at least one material selected from the group consisting of: glass, ceramic, plastic, polymer, and substantially UV resistant material.

9. The apparatus of any preceding claim, wherein the housing structure comprises optically transmissive, optionally molded, core material element (3) encapsulating said at least one substantially point-like source of light to provide a third barrier of insulation against the environment, said core material optionally supporting said at least one substantially point-like source of light.

10. The apparatus of claim 9, wherein the core material comprises at least one material element selected from the group consisting of: elastomer, silicone, acrylic, polyurethane, olefin based elastomer, and polymer.

11. The apparatus of any of claims 9-10, wherein the core material element is configured for color tuning or light extraction.

12. The apparatus of any preceding claim, comprising at least one closing element (5a, 5b), optionally a lid, flap, or end cap, to hermetically seal the housing structure and/or an element (1, 7) within the housing structure.

13. The apparatus of claim 12, wherein the closing element includes a number of electrically conductive portions or elements for supplying power to said at least one substantially point-like source of light.

14. The apparatus of any preceding claim, wherein said at least one substantially point-like source of light includes a LED (light-emitting diode).

15. The apparatus of any preceding claim, wherein said at least one substantially point-like source of light includes a LED strip of a plurality of LEDs.

16. The apparatus of any preceding claim, comprising a cooling element for said at least one source of light.
